(19) United States
(12) Patent Application Publication
(10) Pub. No.: US 2022/0180241 A1
(43) Pub. Date: Jun. 9, 2022

(54) TREE-BASED TRANSFER LEARNING OF TUNABLE PARAMETERS

(71) Applicant: Microsoft Technology Licensing, LLC, Redmond, WA (US)

(72) Inventors: QINGQUAN SONG, Sunnyvale, CA (US); CHENGMING JIANG, Sunnyvale, CA (US); YUNBO OUYANG, Sunnyvale, CA (US); JUN JIA, Sunnyvale, CA (US); HUIJI GAO, Sunnyvale, CA (US); BO LONG, Palo Alto, CA (US); BEE-CHUNG CHEN, San Jose, CA (US); XIA HU, Sunnyvale, CA (US)

(21) Appl. No.: 17/112,824

(22) Filed: Dec. 4, 2020

(51) Int. Cl. G06N 20/00; G06N 5/00

(52) U.S. Cl. CPC G06N 20/00; G06N 5/003

(57) ABSTRACT

Embodiments of the disclosed technologies provide tree-based transfer learning of hyperparameters of a machine learning model or tunable parameters of a black box system. A similar reference task tree is selected from a set of reference task trees. Data is transferred from the similar reference task tree to a target task tree.

### TECHNICAL FIELD

A technical field to which the present disclosure relates is tree-based transfer learning of hyperparameters for machine learning models. Another technical field to which this disclosure relates is black-box optimization.

### BACKGROUND

Most software and hardware-based systems have parameters whose values control the behavior of the system, including how well the system performs, such that changing a parameter value changes the behavior, e.g., performance, of the system in operation. The parameter values are typically determined through a tuning process that is conducted before the system is put into operational use. Once these parameters are tuned, the parameter values generally remain fixed during subsequent phases of system operation.

During a tuning process, parameter are initialized; for example, initial parameter values may be set manually. The parameter values may be adjusted as feedback about the system's behavior is received via simulations or other tuning techniques. An objective function may be used to quantify feedback about the system's performance, such that output of the objective function may be used as a basis to adjust a parameter value. After the parameters have been appropriately tuned, the system may be ready for operational use.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram illustrating at least one embodiment of a computing system in which aspects of the present disclosure may be implemented.

FIG. 2A is a flow diagram of a process that may be used to implement a portion of the computing system of FIG. 1.

FIG. 2B is a flow diagram of a process that may be used to implement a portion of the computing system of FIG. 1.

FIG. 3A is a schematic diagram of a tree construction portion of a tree-based transfer learning process that may be used to implement a portion of the computing system of FIG. 1.

FIG. 3B, FIG. 3C, and FIG. 3D are schematic diagrams of tree comparison portions of a tree-based transfer learning process that may be used to implement a portion of the computing system of FIG. 1.

FIG. 3E is a schematic diagram of a tree selection portion of a tree-based transfer learning process that may be used to implement a portion of the computing system of FIG. 1.

FIG. 4 is a schematic diagram of a data transfer portion of a tree-based transfer learning process that may be executed by at least one device of the computing system of FIG. 1.

FIG. 5A and FIG. 5B are plots that illustrate experimental results obtained by an embodiment of the computing system of FIG. 1.

FIG. 6 is a block diagram illustrating an embodiment of a hardware system, which may be used to implement various aspects of the computing system of FIG. 1.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

Parameter tuning involves finding parameter values that cause a system to operate in an optimal way, whether for machine learning model hyperparameters, configuration parameters of a software system, or control parameters of a hardware-based system. A parameter tuning process can be treated as a block-box optimization problem. In black-box optimization, parameters are tuned through trial and error because there is no information available a priori about which parameter values will achieve desired results, e.g., to maximize the value of the objective function. For example, black-box optimization may be used when an analytic description or gradient of the objective function is not available.

When information about the internal structure or functioning of a system is available, test cases can be designed that test those internal aspects of the system (“white-box” testing). Even when white-box testing can be performed, however, black-box optimization may be preferable to white-box approaches due to the reduced computational complexity and increased speed of black-box optimization. Thus, the term black-box system may be used herein to refer to a black-box system or any system that can be treated as a black-box system.

One approach to parameter tuning is to iteratively run simulations in which a new set of parameter values is chosen for each simulation until a set of parameter values is found that maximizes the objective function. A particular iteration “i” of a simulation may be referred to as a “trial.” The set of parameter values for a given trial may be designated as “x,” where x may be a single parameter value or a vector whose dimensions each contain a value for a different parameter.

The objective function used to evaluate the behavior (e.g., performance) of the system in operation may be referred to as “f(x).” Thus, a traditional optimization loop may involve selecting an xi, testing the system in operational use with x set to xᵢ, determining whether the value of f(xᵢ) satisfies a performance criterion while the system is in operational use, and if f(xᵢ) does not satisfy the performance criterion, choosing a new xᵢ₊₁ and repeating the optimization loop.

The objective function f(x) is selected based on the nature of the system being tuned and the optimization objective. Examples of objective functions that may be used in different use cases are described below with reference to those use cases. Examples of performance criteria are values or ranges of values to which the output of the objective function is compared. For example, a performance criterion might be a threshold minimum value or a threshold maximum value, or a range of acceptable values. A performance criterion is determined based on the nature of the system being tuned and the optimization objective. Examples of optimization objectives include computational speed, efficiency, prediction accuracy, and user satisfaction.

### Example Use Case—Tuning Machine Learning Model Hyperparameters

One example of a tunable parameter is a hyperparameter of a machine learning model. As opposed to other machine learning model parameters that are derived through the training of the machine learning model, the value of a hyperparameter controls the machine learning process itself. For instance, adjusting the value of a hyperparameter can increase or decrease the rate at which the machine learning model learns from training data, which in turn affects the model's efficiency in generating accurate predictions.

An example of an objective function applicable to the machine learning model hyperparameter tuning use case is a function that generates output that can be used to evaluate prediction accuracy, such as a classification accuracy metric for evaluating a classification algorithm; for instance, a machine learning image classification algorithm. Another example of an objective function applicable to the machine learning model hyperparameter tuning use case is, for a neural network, a function that quantifies validation loss, such as a function that quantifies cross-entropy loss on a validation set. Still another example of an objective function applicable to the machine learning model hyperparameter tuning use case is an area under the curve (AUC) metric, which provides an aggregate measure of model performance across classification thresholds.

A technical challenge for a machine learning model hyperparameter tuning system is to select an xᵢ (e.g. a set of hyperparameter values) so that a desired f(x) is achieved accurately and quickly (e.g., with few iterations). One way to choose an xᵢ is through random selection. Another way to select an xᵢ is by leveraging a surrogate model that has already been trained for a previous hyperparameter tuning task. Surrogate models are distinguished from the machine learning models whose hyperparameters are being tuned.

A surrogate model is a model that may be used to help the tuning system find the hyperparameter values that optimize the objective function; i.e. the hyperparameter values that cause the machine learning model to perform at a desired level of accuracy and/or efficiency while in operational use. Once those hyperparameter values are found, they are incorporated into the machine learning model and the tuned machine learning model may be trained with training data, brought online, or otherwise put into operational use.

Surrogate models operate as follows: given a search space (e.g., a range of values) from which an x value may be chosen, executing a search algorithm over the search space to determine the next xᵢ to try. Surrogate models can be implemented using, for example, Gaussian process (GP) models or neural network (NN) models. Another approach for a surrogate model is called ensemble GP. In the ensemble GP approach, a GP model for a new tuning task is created based on a set of previously-created GP models that have been trained previously for other tuning tasks. Each of these approaches is very computationally expensive and/or time consuming because large amounts of historical tuning data are required to build the models.

In machine learning, hyperparameter tuning tasks for similar application domains (such as search and recommendations) may share many similarities. For example, neural network models for “people search” and “job search” might have similar model structures in terms of the number of filters and hyperparameters. As another example, training data sets for “job search” and “jobs you may be interested in” may include similar types of job features.

As another example, two machine learning models may have been trained for completely different application domains but may both have a similar structure (e.g., both models are generalized linear mixed (GLMix) models or both models are generalized deep mixed (GDMix) models). The hyperparameter tuning tasks for these two models may have certain similarities despite the fact that the models are trained for different application domains.

Hyperparameters are distinguished from model parameters. As used herein, model parameter may refer to an internal machine learning model parameter value that may be adjusted based on training data inputs for a domain application. Examples of model parameters are weights and biases, which are not considered hyperparameters. In contrast, hyperparameter may be used to refer to parameter values that control the process by which the machine learning model learns model parameters based on the training data. Hyperparameters may be set and tuned before the model parameter training process begins, during the training process, or after the training process concludes and before the model is placed into operational use. Examples of hyperparameters include learning rate, number of hidden layers, and word embedding size.

The process of tuning hyperparameters for a particular machine learning model may be referred to as a tuning task. An application software system may use many different machine learning models in the course of its operation. In order to tune the hyperparameters of each of these different machine learning models, a different tuning task is performed. Thus, the number of tuning tasks needing to be performed typically corresponds to the number of machine learning models used by a system.

When there are many tuning tasks to be performed, efforts to improve efficiency may include attempts to apply the results of one tuning task to expedite another tuning task. While it may seem intuitive that similar models should produce similar tuning results, this assumption has proven not reliable. Thus, a technical challenge is that the tuning tasks that are used to tune hyperparameters for similar models do not always produce similar results.

For example, given two machine learning models that have a certain type of similarity, a tuning task performed on a first one of those models may produce a tuned set of hyperparameter values that cause the first model to perform well. However, if those hyperparameter values are transferred to the second model on the basis that the two models are similar, those hyperparameter values tuned for the first model may not give the same level of performance when transferred to the second one of those models. That is, the second model may not achieve the same level of performance even though the two models are similar and the same hyperparameter values are used. In other words, similar models do not always equate to similar tuning tasks. Thus, the intuition of human experts alone is not a reliable mechanism for determining which tuning tasks can be leveraged from one model to another. Determining which tuning tasks are similar for purposes of transfer learning is a complex technical problem.

The disclosed technologies address these and other technical challenges by implementing a tree-based transfer learning approach in which tree representations of tuning tasks are created and used to identify one or more reference tuning tasks that are similar to a target tuning task. As used herein, reference tuning task may refer to a tuning task that has already been completed and thus has already produced a tuned reference model, while target tuning task may refer to a tuning task that is new in the sense that it has not already been completed and thus has not yet produced a tuned model.

The disclosed use of the tree representations of tuning tasks accelerates the process of finding a reference tuning task that is similar to the target tuning task in the sense that the tuned hyperparameter values are likely to result in similar model behavior (e.g. improved model performance) in both the reference model and the target model. Also, the described algorithmic process of finding similar tuning tasks may identify non-intuitive tuning task similarities that human experts may be unlikely to uncover.

Once a reference tuning task is found that is similar to a target tuning task, the tree-based representations of the tuning tasks are used to transfer parameter data from the reference tuning task to the target tuning task. As described in more detail below, the disclosed technologies are capable of using two different transfer techniques, e.g., pointwise and spacewise techniques, alternatively or in combination, to transfer parameter data from the reference tuning task to the target tuning task. Using these techniques, the disclosed technologies can transfer tuned parameter data from one tuning task to another in fewer iterations and with higher accuracy, even when the computational complexity of the underlying machine learning model is high.

### Other Use Cases

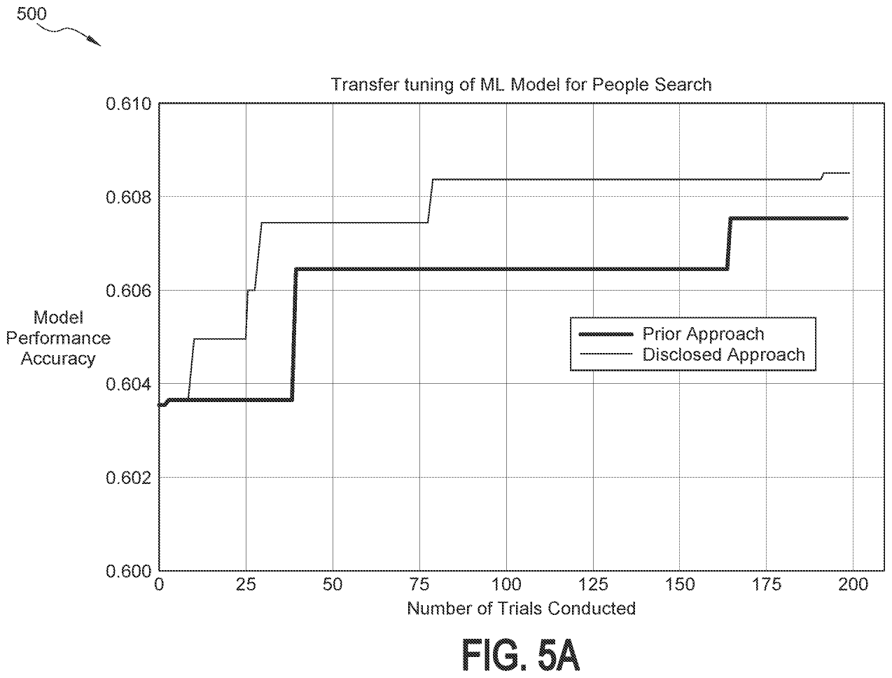

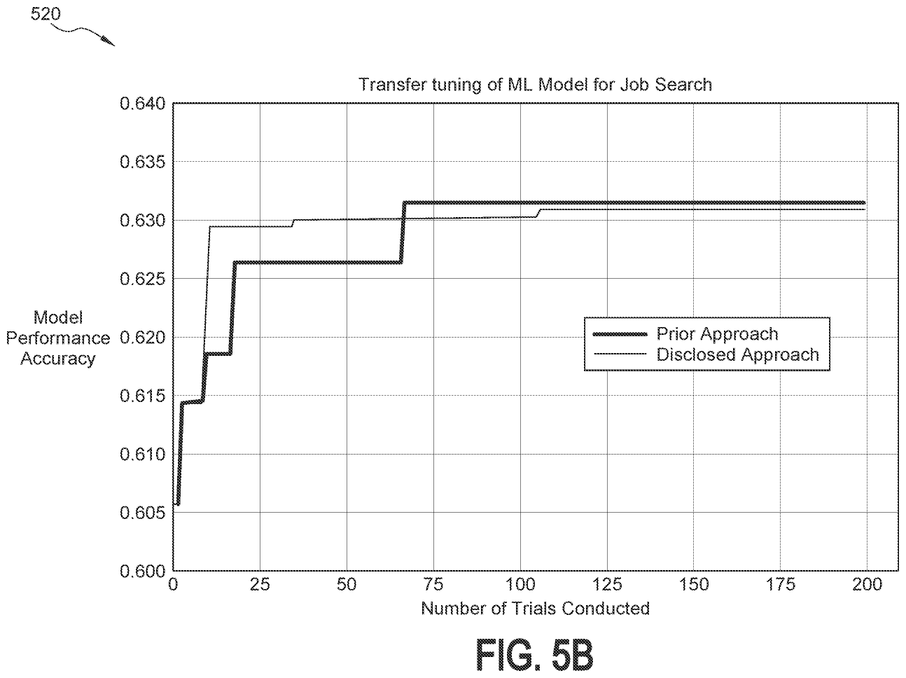

As indicated by FIG. 5A and FIG. 5B, described below, experiments have shown that the disclosed technologies are capable of, for example, improving the speed and accuracy of machine learning model hyperparameter tuning. Certain of the disclosed embodiments and experimental results are described in the context of machine learning model hyperparameter tuning. However, it should be understood that the disclosed technologies are not limited to hyperparameter tuning applications but may be used to perform black-box optimization in other contexts.

For instance, tuning parameters to optimize user experience with a graphical user interface can be treated as a black-box optimization task to which the disclosed techniques can be applied. In this context, an example of a tunable parameter of a software system is a configuration setting, such as a color or font size used by a web service to display a graphical user interface. Adjusting the color or font size value can improve or detract from the user's experience with the user interface. An example of an objective function used to measure system performance in this context is a user experience metric that quantifies the quality of the user experience, such as time-on-task, time-to-click, navigation vs. search, task success rate, and ease-of-use rating.

In another example, tuning parameters to optimize performance of a physical system can be treated as a black-box optimization task to which the disclosed techniques can be applied. In this context, an example of a tunable parameter is a control parameter of a physical system, such as execution speed of a back-end job scheduling system. Adjusting the value of the control parameter can increase or decrease the system's job throughput, for example. An example of an objective function used to measure system performance in this context is time to job completion for a particular type of job.

### Example Computing System

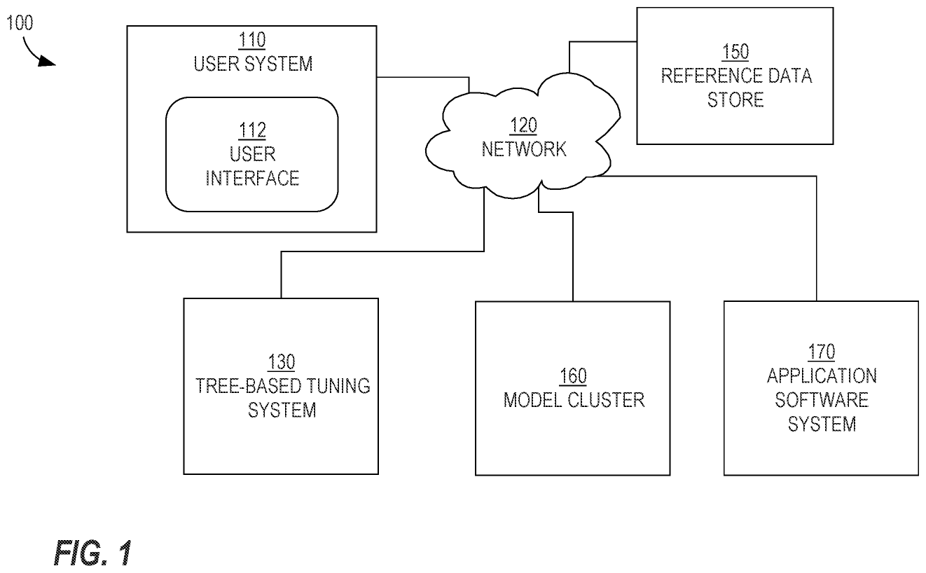

FIG. 1 illustrates a computing system in which embodiments of the features described in this document can be implemented. In the embodiment of FIG. 1, computing system 100 includes a user system 110, a tree-based tuning system 130, a reference data store 150, a model cluster 160, and an application software system 170.

User system 110 includes at least one computing device, such as a personal computing device, a server, a mobile computing device, or a smart appliance. User system 110 includes at least one software application, including a user interface 112, installed on or accessible by a network to a computing device. For example, user interface 112 may be or include front-end portions of tree-based tuning system 130, model cluster 160, and/or application software system 170.

User interface 112 is any type of user interface as described above. User interface 112 may be used to view or otherwise perceive output produced by tree-based tuning system 130, model cluster 160, and/or application software system 170. For example, user interface 112 may include a graphical user interface alone or in combination with an asynchronous messaging interface, which may be text-based or include a conversational voice/speech interface.

Tree-based tuning system 130 is configured to perform tree-based transfer learning of tunable parameters of a black-box system or machine learning model using the techniques described herein. Tree-based tuning system 130 creates tree representations of tuning tasks, uses those tree representations of tuning tasks to identify similar tuning tasks, and, once similar tuning tasks are identified, to transfer parameter data between the similar tuning tasks. Example implementations of the functions and components of tree-based tuning system 130 are shown in the drawings and described in more detail below.

Model cluster 160 includes one or more machine learning models, which have one or more hyperparameters that need to be tuned. Model cluster 160 may also include one or more machine learning models that have hyperparameters that already have been tuned. Portions of model cluster 160 may be part of or accessed by or through another system, such as tree-based tuning system 130 or application software system 170.

Application software system 170 is any type of application software system. Examples of application software system 170 include but are not limited to connections network software and systems that may or may not be based on connections network software, such as job search software, recruiter search software, sales assistance software, advertising software, learning and education software, or any combination of any of the foregoing.

While not specifically shown, it should be understood that any of tree-based tuning system 130, model cluster 160 and application software system 170 includes an interface embodied as computer programming code stored in computer memory that when executed causes a computing device to enable bidirectional communication between application software system 170 and/or model cluster 160 and tree-based tuning system 130. For example, a front end of application software system 170 or model cluster 160 may include an interactive element that when selected causes the interface to make a data communication connection between application software system 170 or model cluster 160, as the case may be, and tree-based tuning system 130. For example, a detection of user input by a front end of application software system 170 or model cluster 160 may initiate data communication with tree-based tuning system 130 using, for example, an application program interface (API).

Reference data store 150 includes at least one digital data store that stores, for example, tree representations of reference tuning tasks and target tuning tasks. Tree representations of reference tuning tasks may be used as inputs to tree-based tuning system 130. Other examples of data that may be stored in reference data store 150 include but are not limited to model training data, parameter values, and machine learning model hyperparameter values. Stored data of reference data store 150 may reside on at least one persistent and/or volatile storage device that may reside within the same local network as at least one other device of computing system 100 and/or in a network that is remote relative to at least one other device of computing system 100. Thus, although depicted as being included in computing system 100, portions of reference data store 150 may be part of computing system 100 or accessed by computing system 100 over a network, such as network 120.

A client portion of tree-based tuning system 130, model cluster 160 or application software system 170 may operate in user system 110, for example as a plugin or widget in a graphical user interface of a software application or as a web browser executing user interface 112. In an embodiment, a web browser may transmit an HTTP request over a network (e.g., the Internet) in response to user input that is received through a user interface provided by the web application and displayed through the web browser. A server portion of tree-based tuning system 130 and/or model cluster 160 and/or application software system 170 may receive the input, perform at least one operation using the input, and return output using an HTTP response that the web browser receives and processes.

Each of user system 110, tree-based tuning system 130, model cluster 160 and application software system 170 is implemented using at least one computing device that is communicatively coupled to electronic communications network 120. Tree-based tuning system 130 is bidirectionally communicatively coupled to user system 110, model cluster 160 and application software system 170, by network 120. A different user system (not shown) may be bidirectionally communicatively coupled to application software system 170. A typical user of user system 110 may be an end user of application software system 170 or an administrator of tree-based tuning system 130, model cluster 160, or application software system 170. User system 110 is configured to communicate bidirectionally with at least tree-based tuning system 130, for example over network 120. Examples of communicative coupling mechanisms include network interfaces, inter-process communication (IPC) interfaces and application program interfaces (APIs).

The features and functionality of user system 110, tree-based tuning system 130, reference data store 150, model cluster 160, and application software system 170 are implemented using computer software, hardware, or software and hardware, and may include combinations of automated functionality, data structures, and digital data, which are represented schematically in the figures. User system 110, tree-based tuning system 130, reference data store 150, model cluster 160, and application software system 170 are shown as separate elements in FIG. 1 for ease of discussion but the illustration is not meant to imply that separation of these elements is required. The illustrated systems and data stores (or their functionality) may be divided over any number of physical systems, including a single physical computer system, and can communicate with each other in any appropriate manner.

Network 120 may be implemented on any medium or mechanism that provides for the exchange of data, signals, and/or instructions between the various components of computing system 100. Examples of network 120 include, without limitation, a Local Area Network (LAN), a Wide Area Network (WAN), an Ethernet network or the Internet, or at least one terrestrial, satellite or wireless link, or a combination of any number of different networks and/or communication links.

It should be understood that computing system 100 is just one example of an implementation of the technologies disclosed herein. While the description may refer to FIG. 1 or to “system 100” for ease of discussion, other suitable configurations of hardware and software components may be used to implement the disclosed technologies. Likewise, the particular embodiments shown in the subsequent drawings and described below are provided only as examples, and this disclosure is not limited to these exemplary embodiments.

### Example Tree-Based Tuning System

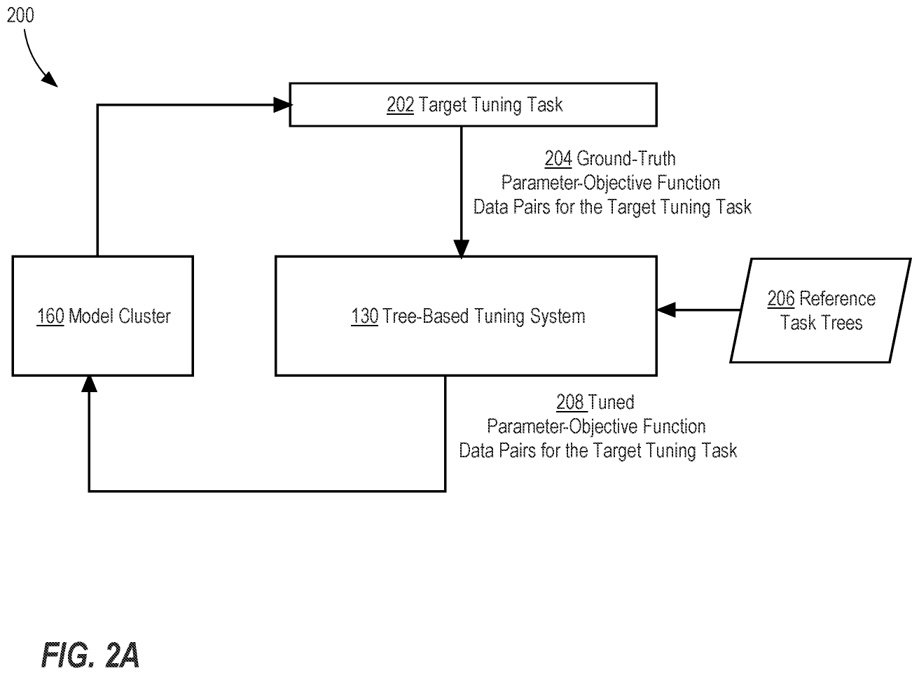

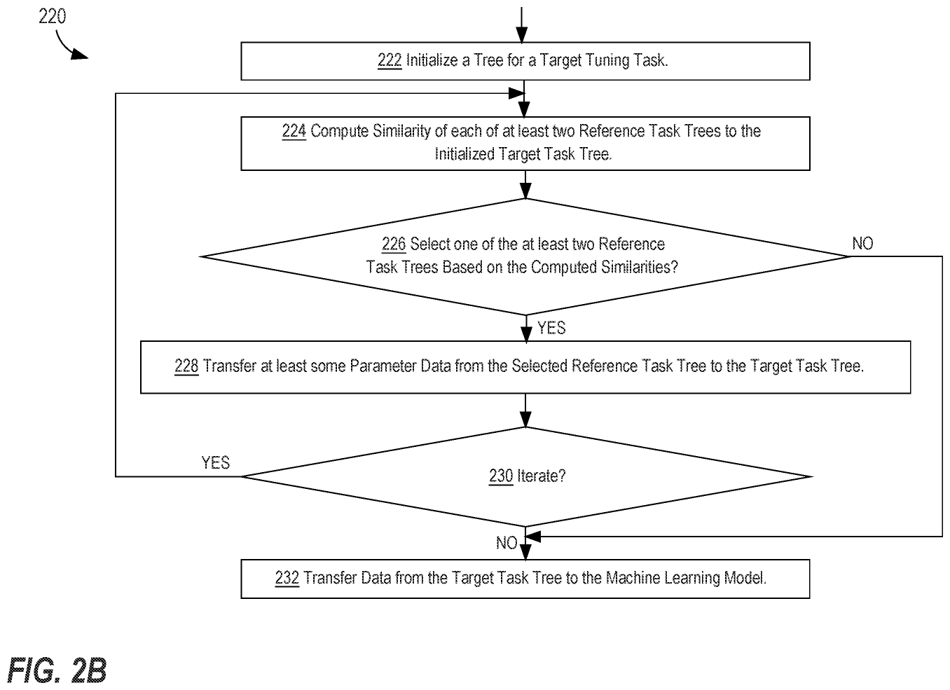

FIG. 2A is a simplified flow diagram of an embodiment of operations and components of a computing system capable of performing aspects of the disclosed technologies. The operations of a flow 200 as shown in FIG. 2A can be implemented using processor-executable instructions that are stored in computer memory. For purposes of providing a clear example, the operations of FIG. 2 are described as performed by computing system 100, but other embodiments may use other systems, devices, or implemented techniques.

In FIG. 2A, a target tuning task 202 may be initiated by application software system 170 for a target model of model cluster 160 that needs to be tuned. Target tuning task 202 is an automated or semi-automated process that includes tuning one or more hyperparameters of the target model of model cluster 160. Target tuning task 202 is a new tuning task in the sense that the one or more hyperparameters of the target model previously have not been tuned for the particular target model needing tuning. That is, the hyperparameters that need to be tuned for the target model may have been tuned previously for one or more other models stored in model cluster 160, but have not been tuned for this particular, target, model.

Target tuning task 202 provides as input to tree-based tuning system 130 an initial dataset of ground-truth parameter-objective function data pairs 204, which have been generated for target tuning task 202. The initial dataset of ground-truth parameter-objective function data pairs 204 that have been generated for target tuning task 202 may be referred to as a target task data set.

The target task dataset may be produced through experimentation using, for example, a simulation. An individual ground-truth parameter-objective function data pair of the target task dataset contains a ground-truth parameter value for one or more tunable parameters of the target model needing tuning and an objective function value that has been produced by inputting the ground truth parameter value into the objective function during the experimentation or simulation. In other words, a ground-truth parameter-objective function data pair may be represented as (x, f(x)).

The choice of objective function is determined by the requirements or design of the particular implementation of the model needing to be tuned. In general, the objective function defines the objective of the tuning task, whether it be to reach a desired level of user experience, processing speed, throughput, computational efficiency, prediction accuracy, and/or other optimization objectives.

Tree-based tuning system 130 ingests the target task dataset and uses the target task dataset to, in computer memory, create a tree-based representation of target tuning task 202. The tree-based representation of target tuning task 202 may be referred to as a target task tree. Tree-based tuning system 130 compares the target task tree to one or more reference task trees 206. Reference task trees 206 are tree-based representations of reference tuning tasks. Reference tuning tasks are tuning tasks that have been previously completed for tuning tasks that are different but which may be similar in some way to target tuning task 202; for example hyperparameters that already have been tuned for a machine learning model used in a different application domain.

Each of reference task trees 206 is or has been created using a reference task dataset. A reference task dataset used to create a particular reference task tree 206 contains historical tuned parameter-objective function data pairs that have been produced through a previously-performed reference tuning task. An individual historical tuned parameter-objective function data pair of the reference task dataset contains a previously tuned parameter value for one or more tunable parameters of the reference model that has been tuned by the reference tuning task and an objective function value that has been produced by inputting the previously tuned parameter value into the objective function during the reference tuning task. A historical tuned parameter-objective function data pair may be represented as (x, f(x)).

Reference task trees 206 may be created and stored as target systems or models of model cluster 160 are tuned, or reference task trees may be created on the fly as the need arises; for example, in response to a new target tuning task being initiated. Tree and tree-based representation as used herein may refer to a tree data structure that is stored in computer memory. Reference task trees and target task trees may be stored in, for example, reference data store 150.

A tree data structure is made up of nodes and edges that represent relationships between the nodes connected by the edges. Each node contains its own data structure. The tree data structure may be hierarchical in the sense that the root node may contain an entire data set (e.g., all parameter-objective function data pairs for a given tuning task) and leaf nodes may contain different subsets of the entire data set, where the subsets are determined by a decision rule (which may also be referred to as a partition rule) at each level of the tree. For example, the dataset of the root node may be recursively split according to a partition rule f(x)>=t, where t is a threshold value, such that elements of the dataset for which f(x)<t are assigned to one leaf node and elements of the dataset for which f(x)>=t are assigned to a different leaf node. The threshold value t may be set based on the requirements of a particular design or implementation of system 100.

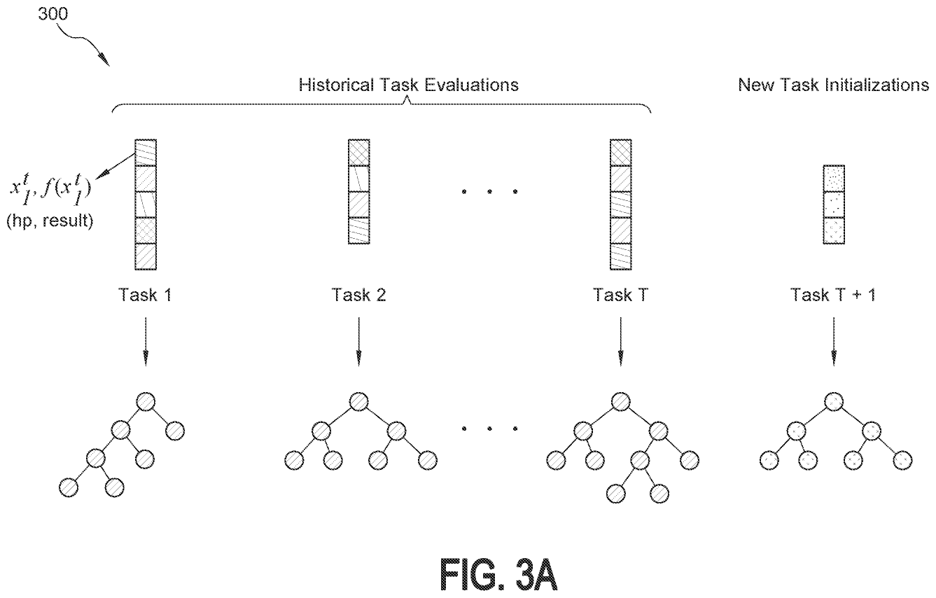

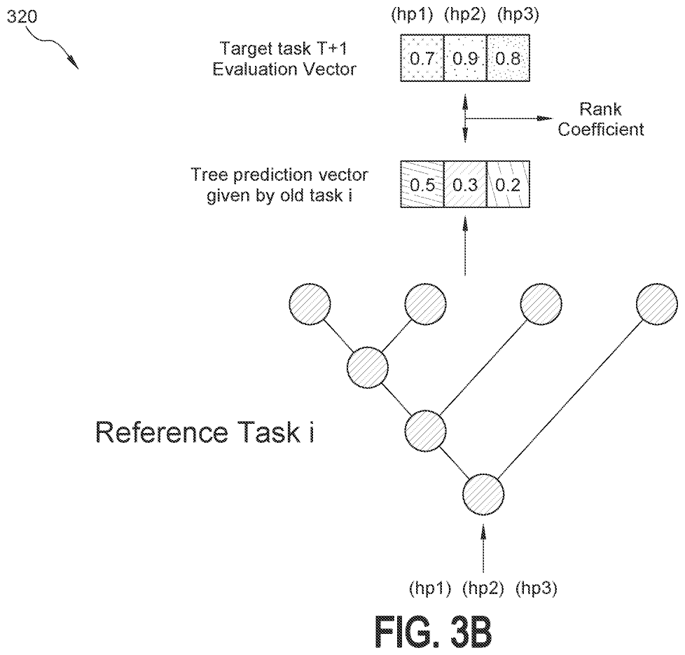

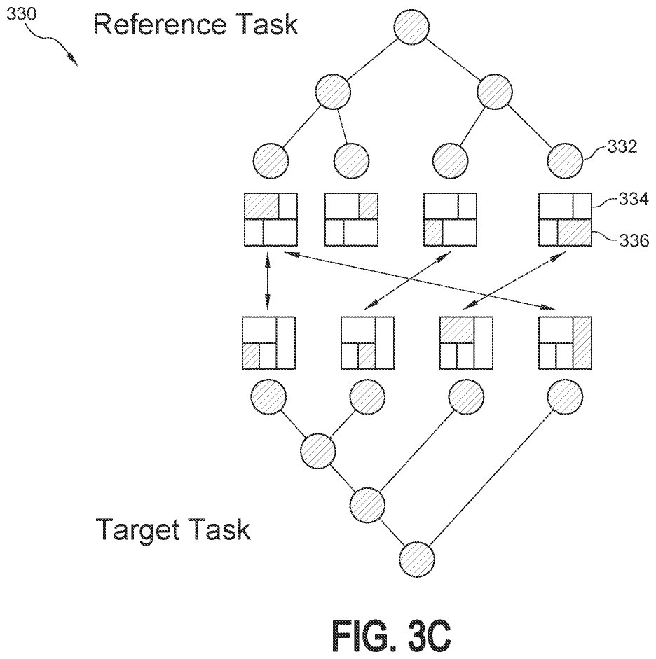

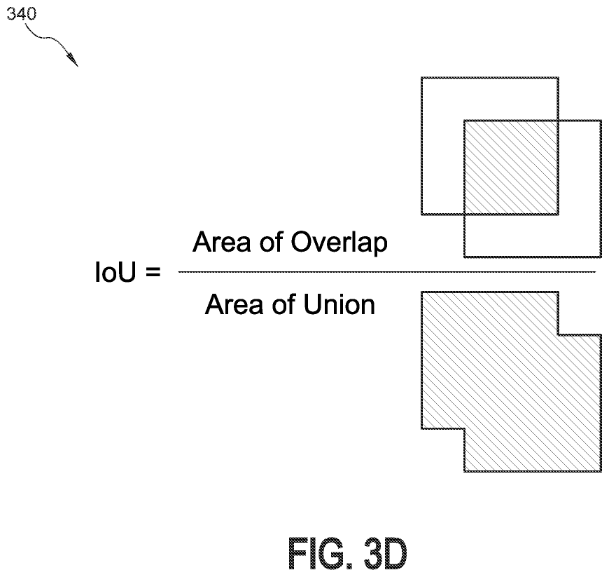

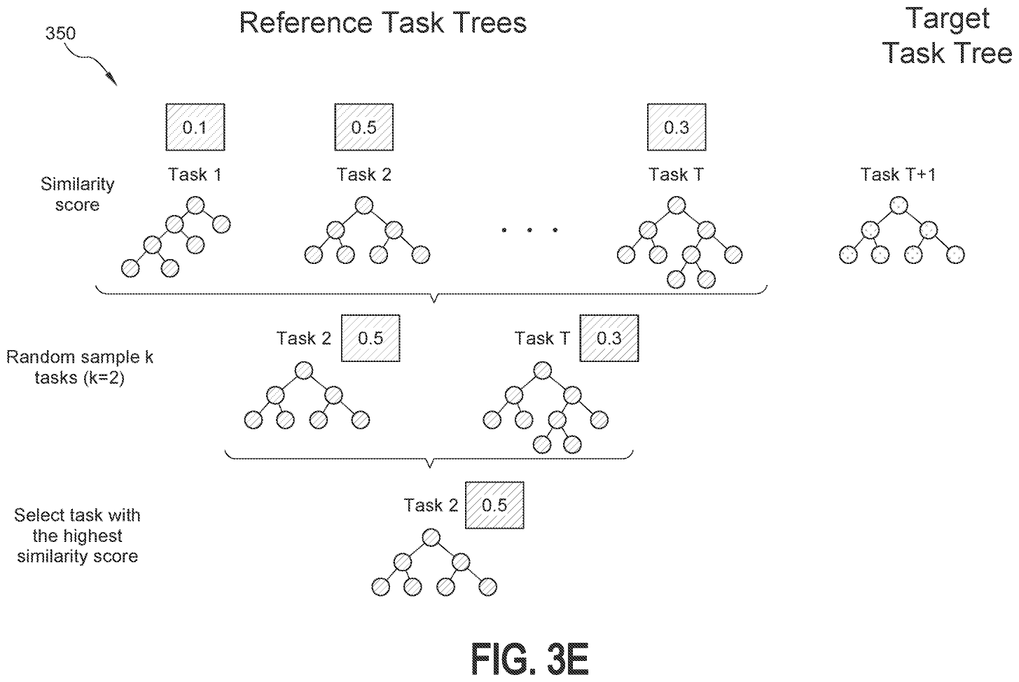

Tree-based tuning system 130 computes similarity metrics between the target task tree and one or more of the reference task trees 206, and selects one of the reference task trees based on the similarity metrics. Examples of similarity metrics are described below with reference to FIG. 3B, FIG. 3C, and FIG. 3D. An example of a method of selecting a reference task tree is described below with reference to FIG. 3E.

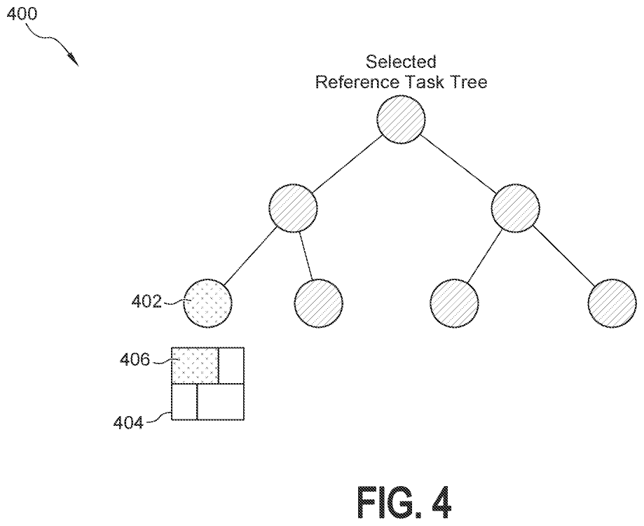

Tree-based tuning system 130 transfers parameter data from the selected reference task tree to the target task tree. Examples of methods for transferring data from a selected reference task tree to the target task tree are described below with reference to FIG. 4. The process of transferring parameter data from the selected reference task tree to the target task tree may complete the target task tree and produce tuned parameter-objective function data pairs 208 for the target tuning task 202.

After the process of transferring parameter data from the selected reference task tree to the target task tree is complete, tuned parameter values of the tuned parameter-objective function data pairs 208 are incorporated into the target model of model cluster 160 that needed to be tuned. As a result, the target model of model cluster 160 that needed to be tuned is tuned using a tree-based transfer learning approach by which certain tunable parameters of the target model that needed to be tuned have been obtained from a similar previously-conducted tuning task.

### Example Tree-Based Transfer Learning Process

FIG. 2B is a simplified flow diagram of an embodiment of operations that can be performed by at least one device of a computing system. The operations of a flow 200 as shown in FIG. 2B can be implemented using processor-executable instructions that are stored in computer memory. For purposes of providing a clear example, the operations of FIG. 2 are described as performed by computing system 100, but other embodiments may use other systems, devices, or implemented techniques.

Operation 222 when executed by at least one processor causes one or more computing devices to initialize a tree for a target tuning task. In an embodiment, operation 222 may include using a target task data set, constructing, in computer memory, a target task tree, where the target task tree is a tree-based representation of a target tuning task and the target task data set includes an initial set of ground-truth parameter-objective function data pairs for the target tuning task. In an embodiment, the initial set of ground-truth parameter-objective function data pairs may be determined manually through experimentation or simulation.

Operation 224 when executed by at least one processor causes one or more computing devices to compute a similarity metric that, for each of at least two reference task trees, represents a comparison of the reference task tree to the target task tree that was initialized in operation 222. In an embodiment, operation 224 includes, for each of at least two reference task trees stored in computer memory, computing a similarity metric between the reference task tree and the target task tree, where the at least two reference task trees are each constructed using different reference task data sets, and the different reference task data sets each include a plurality of historical tuned parameter-objective function data pairs for a reference tuning task that is different than the target tuning task. Examples of methods for computing similarity metrics are described below with reference to FIG. 3B, FIG. 3C, and FIG. 3D.

Operation 226 when executed by at least one processor causes one or more computing devices to determine whether to select one of the at least two reference task trees based on the computed similarities. In an embodiment, operation 226 includes determining whether the similarity score for any of the at least two reference task trees satisfies a similarity score criterion. Examples of methods for determining whether a similarity score for a given reference task tree satisfies a similarity score criterion include determining whether a similarity score for the given reference tree is the highest out of all similarity scores computed for all reference task trees, and determining whether the similarity score for any reference task tree exceeds a threshold value. The methods for determining whether to select a reference task tree may be determined based on the requirements of a particular design or implementation of the computing system 100.

It is possible that none of the reference task trees may be similar enough to the target task tree in order to be used effectively for transfer learning. When there are no reference task trees having similarity scores that satisfy the similarity criterion, no reference task tree is selected and flow 220 proceeds to operation 232, described below, or flow 220 terminates.

An example of an instance in which flow 220 may proceed to operation 232 even if operation 226 has not selected a reference task tree is when flow 220 has conducted one or more previous iterations. For instance, a first iteration of flow 220 may result in a portion of parameter data of a first selected reference task tree being transferred to the target task tree. At operation 230, described below, flow 220 may determine to iterate so as potentially further populate the target task tree. In that case, during the second iteration of flow 220, it may be determined at operation 226 that no reference task tree meets the similarity requirements. Nonetheless, in this case, there is parameter data that already has been transferred from the first reference task tree to the target task tree, and since the target task tree has been updated with transferred parameter data, flow 220 proceeds to operation 232.

If, at operation 226, it is determined that one of the at least two reference task trees satisfies the similarity criterion, then the reference task tree that satisfies the similarity criterion is selected and flow 220 proceeds to operation 228. An example of a particular method of selecting a reference task tree, which may be used to implement operation 226, is described below with reference to FIG. 3E.

Operation 228 when executed by at least one processor causes one or more computing devices to transfer at least some parameter data from the selected reference task tree to the target task tree. In an embodiment, operation 228 includes transferring parameter data from the reference task tree selected in operation 226 to the target task tree initialized in operation 222, to produce a tuned target task tree. Examples of methods for transferring data from a selected reference task tree to the target task tree are described below with reference to FIG. 4.

Operation 230 when executed by at least one processor causes one or more computing devices to determine whether to perform another iteration of reference task tree similarity evaluation, reference task tree selection, and parameter data transfer. Operation 230 may determine to iterate if, for example, no reference task tree has satisfied the similarity criterion as determined by operation 226. Operation 230 may alternatively or in addition determine to iterate if parameter data that has been transferred from a selected reference task tree to a target task tree does not satisfy a performance criterion for the target tuning task.

Operation 232 when executed by at least one processor causes one or more computing devices to transfer data from the target task tree to the target machine learning model. As a result, data from the tuned target task tree of operation 228 is incorporated into the target machine learning model needing tuning. To incorporate data from the tuned target task tree into the target machine learning model, specific parameter values may be copied directly from the tuned target task tree into a data structure of the target machine learning model. Alternatively or in addition, a search subspace defined by a leaf node of the tuned target task tree may be searched using a surrogate model such as a GP model or neural network model, in which case the search identifies a specific parameter value to be incorporated into the target machine learning model.

### Example of Tree Construction

FIG. 3A is a schematic diagram of trees 300 that may be constructed and/or used by a tree construction portion of a tree-based transfer learning process that may be used to implement a portion of the computing system of FIG. 1. Trees 300 include tree-based representations of each of T reference tuning tasks, where T is a positive integer, and a new, target task, T+1. Each reference tuning task corresponds to a previously tuned machine learning model, and is defined by a set of historical task evaluations x, f(x).

The vertical column of cells shown for each of Task 1, Task 2, Task T represents the reference task data set for that particular task, and each individual cell in a vertical column represents one historical trial, e.g., one tunable parameter-objective function data pair. In the machine learning model hyperparameter tuning example, each cell in the vertical column represents a hyperparameter (“hp”)-objective function result pair. The reference task data set for a particular reference tuning task is used to create the corresponding tree-representation of the particular reference tuning task.

A given reference task tree is constructed by assigning the plurality of parameter value-objective function data pairs to particular nodes of the reference task tree according to a decision rule that relates to a performance criterion for the particular reference tuning task. The decision rule may be learned through supervised machine learning, for example using a regression model. Thus, each reference tuning task has a corresponding reference task tree which may be different from any other reference task tree. Since the reference task trees are created from historical data sets from tuning tasks that have already been completed, the reference task trees may be considered fixed.

Similarly, a target task tree is initialized for the new, target tuning task T+1. Individual cells in the vertical column for the target tuning task each represent a ground-truth parameter-objective function data pair, e.g., x, f(x). The target task tree is constructed by assigning the plurality of ground-truth parameter-objective function data pairs to particular nodes of the target task tree according to a decision rule that relates to a performance criterion for the machine learning model. Initialization builds the target task tree using an initial data set. Since the target tuning task has not been completed, the target task tree is not fixed. As a result, leaf nodes of the target task tree can be modified or added from one or more reference task trees using the disclosed technologies.

It should be noted that each reference tuning task may be a different type of tuning task both from the other reference tuning tasks and from the target tuning tasks. Thus, although the parameter-objective function pairs are referenced herein as x, f(x), it should be understood that x and f(x) may be different for each tuning task. That is, the objective functions need not be the same as between any reference tuning task and the target tuning task. The decision rules used to create the tree-based representations of reference tuning tasks and the target tuning task may be different, as well.

Also, after the reference task trees and target task tree are constructed, each leaf node represents a subspace of the entire search space of parameter-objective function pairs, and the leaf nodes are used to compare the similarity between the different tuning tasks. Once a reference task tree is found to be similar to the target task tree, a subspace of one or more of the leaf nodes of the reference task tree may be transferred to one or more leaf nodes of the target task tree. A surrogate model may then be used to search the transferred subspace. In this way, the disclosed technologies do not use trees as surrogate models but rather to find better subspaces to be searched.

### Examples of Similar Tuning Task Identification

FIG. 3B, FIG. 3C, and FIG. 3D are schematic diagrams of tree comparison portions of a tree-based transfer learning process that may be used to implement a portion of the computing system of FIG. 1.

In an embodiment illustrated by FIG. 3B, the similarity metric between a reference task tree and the target task tree is computed by fitting ground-truth parameter-objective function data pairs of leaf nodes of the target task tree to leaf nodes of the selected reference task tree, and performing pairwise comparisons of the fitted ground-truth parameter-objective function data pairs to historical tuned parameter-objective function data pairs of the leaf nodes of the selected reference task tree. The similarity metric may be computed by calculating a Kendall Tau-b rank correlation coefficient based on the pairwise comparisons of the fitted ground-truth parameter-objective function data pairs to the historical tuned parameter-objective function data pairs of the leaf nodes of the reference task tree.

In FIG. 3B, the target task tree for the new target task T+1 has been initialized by sampling initial parameter-objective function pairs for three tunable parameters: (hp1, 0.7), (hp2, 0.9), (hp3, 0.8), where hp1, hp2, and hp3 represent the initial values of three different hyperparameters and 0.7, 0.9, 0.8 represent the objective function output f(x) for each of the three hyperparameter values, respectively, where a higher value of f(x) indicates that the machine learning model being tuned achieved better performance. Thus, of the three hyperparameter values, hp2 achieved the highest performance and hp1 had the lowest performance.

These initial values of hp1, hp2 and hp3 are fit into one of the reference task trees to see what objective function values the reference task tree would predict for those inputs. In the illustration of FIG. 3B, fitting hp1, hp2, and hp3 into the reference task tree for the old task i produced corresponding objective function values 0.5, 0.3, 0.2. The objective functions for the target task tree and reference task trees need not be the same because the similarity metric computation does not use a pointwise comparison of absolute values but rather evaluates the alignment of those values.

For instance, in the example of FIG. 3B, the computation of the similarity metric includes pairwise comparisons of the dimensions of the new target task prediction vector to the corresponding dimensions of the reference task prediction vector. In FIG. 3B, the new target task data pair (hp2, 0.9), (hp3, 0.8) is aligned with the reference task data pair (hp2, 0.3), (hp3, 0.2) because in both cases, the hp2 objective function output is higher than the hp3 objective function output. However, the new target task data pair (hp1, 0.7), (hp2, 0.9) is not aligned with the reference task data pair (hp1, 0.5), (hp2, 0.3), because the hp1 objective function output is lower than the hp2 objective function output for the target task but the hp1 objective function output is higher than the hp2 objective function output for the reference task. The similarity metric computation takes into consideration the fact that part of the reference task tree is computationally aligned with the target task tree but another part of the reference task tree is not aligned with the target task tree in this manner.

In another embodiment illustrated by FIG. 3C and FIG. 3D, the similarity metric may be computed using the tree-partitioned subspaces. The similarity metric may be computed by creating target task tree leaf node subspace-reference task tree leaf node subspace pairs, and calculating an intersection over union score using the target task tree leaf node subspace-reference task tree leaf node subspace pairs. This approach compares the subspace similarity in each leaf node.

As shown in FIG. 3C, the subspaces partitioned by the decision rules for the target task tree and the reference task tree, respectively, are compared and the best-matching pairs are identified based on an average mean value computed in each subspace. In the example of FIG. 3C, space 334 (the entire square) represents the entire search space encompassed by the reference task data set and subspace 336 represents the particular subspace of leaf node 332. The bidirectional arrows indicate matching pairs of leaf nodes of the reference task tree to leave nodes of the target task tree.

As shown by FIG. 3D, the intersection over union (IoU) score is computed between each pair of matched subspaces. The IoU scores are averaged across all hyperparameters and then averaged over all of the subspaces to produce a single value that represents the similarity of the target task tree-reference task tree pair. The Kendall Tau-b approach described with reference to FIG. 3B may be more suitable when preliminary experiments and later performed experiments use the same model, for example. The IoU approach described with reference to FIG. 3C may be faster than the Kendall Tau-b approach and thus may be more suitable when the target task data set is large.

### Example of Tree Selection

FIG. 3E is a schematic diagram of a tree selection portion of a tree-based transfer learning process that may be used to implement a portion of the computing system of FIG. 1. In an embodiment, a reference task tree is selected using a tournament selection method in which k reference task trees of the at least two reference task trees are randomly selected, where k is greater than one and less than T, where T is a total number of reference task trees, and the reference task tree as having a highest value of the similarity metric from among the k reference task trees is selected for data transfer to the target task tree.

In the example of FIG. 3E, a set of reference task trees 350 includes task trees for Task 1, Task 2 up to task T, where T is a positive integer. Similarity scores indicating similarity of each of the reference task trees to the target task tree T+1, which may have been computed using one of the above-described techniques, are indicated above each tree. Using the tournament selection method with k=2, the reference task trees for Task 2 and Task T are randomly selected. From the random sample of k tasks, a task with the highest similarity score is selected (here, Task 2). Although directly selecting Task 2 in the first round would have yielded the same result in this example, using the tournament approach allows for exploration in the event that the similarity scores are noisy. The number of random samples, k, is greater than 1 and less than T in this example.

### Example of Tree-Based Data Transfer

FIG. 4 is a schematic diagram of a data transfer portion of a tree-based transfer learning process that may be executed by at least one device of the computing system of FIG. 1.

In an embodiment, the transfer of data from a selected reference task tree to the target task tree includes iteratively performing at least one of a pointwise transfer of a particular parameter value of a particular leaf node of the reference task tree to the target task tree and a spacewise transfer of a search space of the particular leaf node to the target task tree. The transferring of parameter data from the selected reference task tree to the target task tree may be stopped when a rejecting rule that relates to a performance criterion of the machine learning model system is satisfied.

In FIG. 4, a selected reference task tree 400 includes four leaf nodes, of which a leaf node 402 has a corresponding subspace 406 of the entire search space 404, where the search space 404 is defined by the root node of the reference task tree 400. In a pointwise data transfer, individual parameter values from leaf node 402 are transferred directly to a leaf node of the target task tree. After a pointwise transfer, the updated target task tree is tested using its objective function. If the results of testing satisfy a performance criterion for the target tuning task, the data transfer process may end. If the test results do not satisfy the performance criterion, another iteration of pointwise data transfer may be conducted using a different leaf node of the reference task tree, or another reference task tree may be selected altogether, for the next iteration.

A spacewise transfer may be conducted alternatively or in addition to the pointwise transfer. For example, if the pointwise transfer performs poorly, the system 100 may switch to spacewise transfer. In the spacewise transfer, the subspace 406 is transferred to the target task tree rather than the individual parameter values. Subspace transfers may be performed iteratively in a similar manner, with test results determining whether to perform another iteration or to switch to pointwise transfer. In an embodiment, a Bayesian optimization algorithm with upper confidence bound acquisition function was used to iteratively perform the similarity comparison, reference tree selection and data transfer portions of the tree-based transfer learning process. The disclosed approach can be used alone or in combination with other algorithms, such as neural network-based searching algorithms.

### Examples of Experimental Results

FIG. 5A and FIG. 5B are plots that illustrate experimental results obtained by an embodiment of the computing system of FIG. 1.

In one experiment, the disclosed technologies were used to perform tree-based transfer learning of hyperparameters of a machine learning model trained for one domain application (e.g., “job search”) to the same machine learning model trained for a different domain application (e.g., “people search”), and the results were compared to a prior hyperparameter tuning approach that did not use tree-based transfer learning over 200 trials. The tunable parameters included 5 hyperparameters: learning rate, Bidirectional Encoder Representations from Transformers (BERT) learning rate, number of filters, number of hidden units, and word embedding size. Thus, x was a 5 dimensional vector.

FIG. 5A shows the results of transferring existing tuning information of the “job search” machine learning model to people search. The x-axis represent the number of trials conducted on the dataset and the y-axis indicates the performance accuracy on the validation dataset. Compared to the prior approach, the disclosed method can accelerate the tuning speed and performance of people search via transferring the historical tuning information from job search, and consistently achieve better results during the 200 trials.

FIG. 5B shows the results of transferring tuning information of the “people search” model back to job search. In this experiment, the people-search results produced using the prior approach in the previous experiment (FIG. 5A) were reversely transferred to boost the performance of the disclosed approach on job-search. FIG. 5B shows that the disclosed approach can quickly achieve good results in the first 50 trials comparing to the prior approach.

The disclosed tree-based transfer learning method can be used to accelerate hyperparameter and black-box optimization by leveraging the parameter tuning data/optimization information previously obtained on historical tasks and outperforms other state of the art transfer learning methods. The disclosed approach can be used to complement other basic non-transfer learning hyperparameter tuning and black box optimization methods with low computational complexity.

### Example Hardware Architecture

According to one embodiment, the techniques described herein are implemented by at least one special-purpose computing device. The special-purpose computing device may be hard-wired to perform the techniques, or may include digital electronic devices such as at least one application-specific integrated circuit (ASIC) or field programmable gate array (FPGA) that is persistently programmed to perform the techniques, or may include at least one general purpose hardware processor programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, mobile computing devices, wearable devices, networking devices or any other device that incorporates hard-wired and/or program logic to implement the techniques.

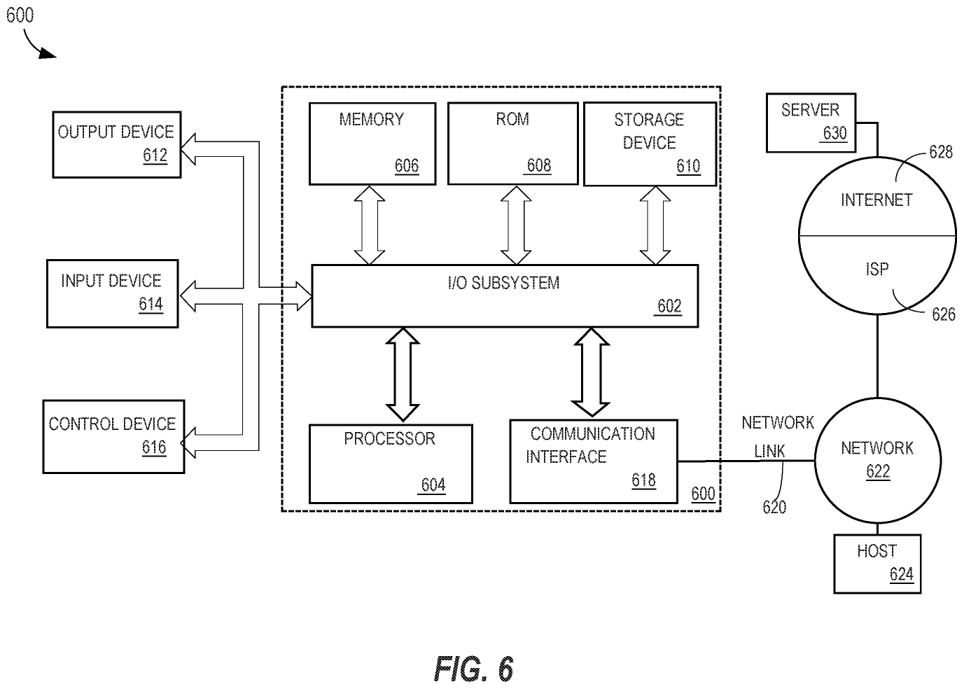

For example, FIG. 6 is a block diagram that illustrates a computer system 600 upon which an embodiment of the present invention may be implemented. Computer system 600 includes a bus 602 or other communication mechanism for communicating information, and a hardware processor 604 coupled with bus 602 for processing information. Hardware processor 604 may be, for example, a general-purpose microprocessor.

Computer system 600 also includes a main memory 606, such as a random-access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory computer-readable storage media accessible to processor 604, render computer system 600 into a special-purpose machine that is customized to perform the operations specified in the instructions.

Computer system 600 and further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to an output device 612, such as a display, such as a liquid crystal display (LCD) or a touchscreen display, for displaying information to a computer user, or a speaker, a haptic device, or another form of output device. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, at least one ASIC or FPGA, firmware and/or program logic which in combination with the computer system causes or programs computer system 600 to be a special-purpose machine. According to one embodiment, the techniques herein are performed by computer system 600 in response to processor 604 executing at least one sequence of instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying at least one sequence of instruction to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated-services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through at least one network to other data devices. For example, network link 620 may provide a connection through local network 622 to a host computer 624 or to data equipment operated by an Internet Service Provider (ISP) 626. ISP 626 in turn provides data communication services through the world-wide packet data communication network commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 530 might transmit a requested code for an application program through Internet 628, ISP 626, local network 622 and communication interface 618. The received code may be executed by processor 604 as it is received, and/or stored in storage device 610, or other non-volatile storage for later execution.

### ADDITIONAL EXAMPLES

Illustrative examples of the technologies disclosed herein are provided below. An embodiment of the technologies may include any of the examples or a combination of the described below.

In an example 1, a method for tuning hyperparameters of a machine learning model, the method including: using digital data including a target task data set, constructing, in computer memory, a target task tree; the target task tree being a tree-based representation of a target tuning task; the target task data set including a plurality of ground-truth hyperparameter-objective function data pairs for the target tuning task; for each of at least two reference task trees stored in computer memory, computing a similarity metric between the reference task tree and the target task tree; the at least two reference task trees each constructed using different reference task data sets; the different reference task data sets each including a plurality of historical tuned hyperparameter-objective function data pairs for a reference tuning task that is different than the target tuning task; selecting a reference task tree of the at least two reference task trees based on the computed similarity metrics; transferring hyperparameter data from the selected reference task tree to the target task tree to produce a tuned target task tree; incorporating data from the tuned target task tree into the machine learning model.

An example 2 includes the subject matter of example 1, further including constructing the target task tree by assigning the plurality of ground-truth hyperparameter-objective function data pairs to particular nodes of the target task tree according to a decision rule that relates to a performance criterion for the machine learning model. An example 3 includes the subject matter of example 1 or example 2, further including computing the similarity metric by fitting ground-truth hyperparameter-objective function data pairs of leaf nodes of the target task tree to leaf nodes of the selected reference task tree, and performing pairwise comparisons of the fitted ground-truth hyperparameter-objective function data pairs to historical tuned hyperparameter-objective function data pairs of the leaf nodes of the selected reference task tree. An example 4 includes the subject matter of example 3, further including computing the similarity metric by computing a Kendall Tau-b rank correlation coefficient based on the pairwise comparisons of the fitted ground-truth hyperparameter-objective function data pairs to the historical tuned hyperparameter-objective function data pairs of the leaf nodes of the selected reference task tree. An example 5 includes the subject matter of any of examples 1-4, further including computing the similarity metric by creating target task tree leaf node subspace-reference task tree leaf node subspace pairs, and calculating an intersection over union score using the target task tree leaf node subspace-reference task tree leaf node subspace pairs. An example 6 includes the subject matter of any of examples 1-5, further including using a tournament selection method to randomly select k reference task trees of the at least two reference task trees, where k is greater than one and less than T, where T is a total number of reference task trees, and selecting the selected reference task tree as having a highest value of the similarity metric from among the k reference task trees. An example 7 includes the subject matter of any of examples 1-6, further including iteratively performing at least one of a pointwise transfer of a particular hyperparameter value of a particular leaf node of the reference task tree to the target task tree and a spacewise transfer of a search space of the particular leaf node to the target task tree. An example 8 includes the subject matter of any of examples 1-7, further including stopping the transferring of hyperparameter data from the selected reference task tree to the target task tree when a rejecting rule that relates to a performance criterion of the machine learning model is satisfied.

In an example 9, a system includes: at least one processor; computer memory operably coupled to the at least one processor; instructions stored in the computer memory that, when executed by the at least one processor, cause the system to be capable of performing operations including: using digital data including a target task data set, constructing, in computer memory, a target task tree; the target task tree being a tree-based representation of a target machine learning model hyperparameter tuning task; the target task data set including a plurality of ground-truth machine learning model hyperparameter-objective function data pairs for the machine learning model hyperparameter target tuning task; for each of at least two reference task trees stored in computer memory, computing a similarity metric between the reference task tree and the target task tree; the at least two reference task trees each constructed using different reference task data sets; the different reference task data sets each including a plurality of historical tuned machine learning model hyperparameter-objective function data pairs for a different reference machine learning model hyperparameter tuning task; selecting a reference task tree of the at least two reference task trees based on the computed similarity metrics; transferring hyperparameter data from the selected reference task tree to the target task tree to produce a tuned target task tree; incorporating at least some of the transferred hyperparameter data from the tuned target task tree into a machine learning model.

An example 10 includes the subject matter of example 9, where the instructions, when executed by the at least one processor, further cause the system to be capable of performing operations including constructing the target task tree by assigning the plurality of ground-truth machine learning model hyperparameter-objective function data pairs to particular nodes of the target task tree according to a decision rule that relates to a performance criterion for the machine learning model. An example 11 includes the subject matter of example 9 or example 10, where the instructions, when executed by the at least one processor, further cause the system to be capable of performing operations including computing the similarity metric by fitting ground-truth machine learning model hyperparameter-objective function data pairs of leaf nodes of the target task tree to leaf nodes of the reference task tree, and performing pairwise comparisons of the fitted ground-truth machine learning model hyperparameter-objective function data pairs to historical tuned machine learning model hyperparameter-objective function data pairs of the leaf nodes of the reference task tree. An example 12 includes the subject matter of example 11, where the instructions, when executed by the at least one processor, further cause the system to be capable of performing operations including computing the similarity metric by computing a Kendall Tau-b rank correlation coefficient based on the pairwise comparisons of the fitted ground-truth machine learning model hyperparameter-objective function data pairs to the historical tuned machine learning model hyperparameter-objective function data pairs of the leaf nodes of the reference task tree. An example 13 includes the subject matter of any of examples 9-12, where the instructions, when executed by the at least one processor, further cause the system to be capable of performing operations including computing the similarity metric by creating target task tree leaf node subspace-reference task tree leaf node subspace pairs, and calculating an intersection over union score using the target task tree leaf node subspace-reference task tree leaf node subspace pairs. An example 14 includes the subject matter of any of examples 9-13, where the instructions, when executed by the at least one processor, further cause the system to be capable of performing operations including using a tournament selection method to randomly select k reference task trees of the at least two reference task trees, where k is greater than one and less than T, where T is a total number of reference task trees, and selecting the reference task tree as having a highest value of the similarity metric from among the k reference task trees. An example 15 includes the subject matter of any of examples 9-14, where the instructions, when executed by the at least one processor, cause the system to be capable of performing operations including iteratively performing at least one of a pointwise transfer of a particular hyperparameter value of a particular leaf node of the reference task tree to the target task tree and a spacewise transfer of a search space of the particular leaf node to the target task tree. An example 16 includes the subject matter of any of examples 9-15, where the instructions, when executed by the at least one processor, cause the system to be capable of performing operations including stopping the transferring of hyperparameter data from the selected reference task tree to the target task tree when a rejecting rule that relates to a performance criterion of the machine learning model is satisfied. In an example 17, a system includes: at least one processor; computer memory operably coupled to the at least one processor; means for configuring the computer memory according to a tuned target task tree; the tuned target task tree created by transferring hyperparameter data from a selected reference task tree to a target task tree; the selected reference task tree selected from a plurality of reference task trees based on similarity metrics; the similarity metrics computed, for each reference task tree of the plurality of reference task trees, between the reference task tree and the target task tree. An example 18 includes the subject matter of example 17, where the plurality of reference task trees each have been constructed using different reference task data sets each including a plurality of historical hyperparameter-objective function data pairs for a different reference hyperparameter tuning task. An example 19 includes the subject matter of example 17 or example 18, where the target task tree is a tree-based representation of a machine learning model hyperparameter tuning task. An example 20 includes the subject matter of example 19, where the target task tree has been created using a target task data set that includes a plurality of ground-truth hyperparameter-objective function data pairs for the machine learning model hyperparameter tuning task.

The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions set forth herein for terms contained in the claims may govern the meaning of such terms as used in the claims. No limitation, element, property, feature, advantage or attribute that is not expressly recited in a claim should limit the scope of the claim in any way. The specification and drawings are to be regarded in an illustrative rather than a restrictive sense.

Terms such as “computer-generated” and “computer-selected” as may be used herein may refer to a result of an execution of one or more computer program instructions by one or more processors of, for example, a server computer, a network of server computers, a client computer, or a combination of a client computer and a server computer.

As used here, “online” may refer to a particular characteristic of a connections network-based system. For example, many connections network-based systems are accessible to users via a connection to a public network, such as the Internet. However, certain operations may be performed while an “online” system is in an offline state. As such, reference to a system as an “online” system does not imply that such a system is always online or that the system needs to be online in order for the disclosed technologies to be operable.

As used herein the terms “include” and “comprise” (and variations of those terms, such as “including,” “includes,” “comprising,” “comprises,” “comprised” and the like) are intended to be inclusive and are not intended to exclude further features, components, integers or steps.

Various features of the disclosure have been described using process steps. The functionality/processing of a given process step potentially could be performed in different ways and by different systems or system modules. Furthermore, a given process step could be divided into multiple steps and/or multiple steps could be combined into a single step. Furthermore, the order of the steps can be changed without departing from the scope of the present disclosure.

It will be understood that the embodiments disclosed and defined in this specification extend to alternative combinations of the individual features mentioned or evident from the text or drawings. These different combinations constitute various alternative aspects of the embodiments.

What is claimed is:

1. A method for tuning hyperparameters of a machine learning model, the method comprising:
using digital data comprising a target task data set, constructing, in computer memory, a target task tree;
the target task tree being a tree-based representation of a target tuning task;
the target task data set comprising a plurality of ground-truth hyperparameter-objective function data pairs for the target tuning task;
for each of at least two reference task trees stored in computer memory, computing a similarity metric between the reference task tree and the target task tree;
the at least two reference task trees each constructed using different reference task data sets;
the different reference task data sets each comprising a plurality of historical tuned hyperparameter-objective function data pairs for a reference tuning task that is different than the target tuning task;
selecting a reference task tree of the at least two reference task trees based on the computed similarity metrics;
transferring hyperparameter data from the selected reference task tree to the target task tree to produce a tuned target task tree;
incorporating data from the tuned target task tree into the machine learning model.

2. The method of claim 1, further comprising constructing the target task tree by assigning the plurality of ground-truth hyperparameter-objective function data pairs to particular nodes of the target task tree according to a decision rule that relates to a performance criterion for the machine learning model.

3. The method of claim 1, further comprising computing the similarity metric by fitting ground-truth hyperparameter-objective function data pairs of leaf nodes of the target task tree to leaf nodes of the selected reference task tree, and performing pairwise comparisons of the fitted ground-truth hyperparameter-objective function data pairs to historical tuned hyperparameter-objective function data pairs of the leaf nodes of the selected reference task tree.

4. The method of claim 3, further comprising computing the similarity metric by computing a Kendall Tau-b rank correlation coefficient based on the pairwise comparisons of the fitted ground-truth hyperparameter-objective function data pairs to the historical tuned hyperparameter-objective function data pairs of the leaf nodes of the selected reference task tree.

5. The method of claim 1, further comprising computing the similarity metric by creating target task tree leaf node subspace-reference task tree leaf node subspace pairs, and calculating an intersection over union score using the target task tree leaf node subspace-reference task tree leaf node subspace pairs.

6. The method of claim 1, further comprising using a tournament selection method to randomly select k reference task trees of the at least two reference task trees, where k is greater than one and less than T, where T is a total number of reference task trees, and selecting the selected reference task tree as having a highest value of the similarity metric from among the k reference task trees.

7. The method of claim 1, further comprising iteratively performing at least one of a pointwise transfer of a particular hyperparameter value of a particular leaf node of the reference task tree to the target task tree and a spacewise transfer of a search space of the particular leaf node to the target task tree.

8. The method of claim 1, further comprising stopping the transferring of hyperparameter data from the selected reference task tree to the target task tree when a rejecting rule that relates to a performance criterion of the machine learning model is satisfied.

9. A system, comprising:
at least one processor;
computer memory operably coupled to the at least one processor;
instructions stored in the computer memory that, when executed by the at least one processor, cause the system to be capable of performing operations comprising:
using digital data comprising a target task data set, constructing, in computer memory, a target task tree;
the target task tree being a tree-based representation of a target machine learning model hyperparameter tuning task;
the target task data set comprising a plurality of ground-truth machine learning model hyperparameter-objective function data pairs for the machine learning model hyperparameter target tuning task;
for each of at least two reference task trees stored in computer memory, computing a similarity metric between the reference task tree and the target task tree;
the at least two reference task trees each constructed using different reference task data sets;
the different reference task data sets each comprising a plurality of historical tuned machine learning model hyperparameter-objective function data pairs for a different reference machine learning model hyperparameter tuning task;
selecting a reference task tree of the at least two reference task trees based on the computed similarity metrics;
transferring hyperparameter data from the selected reference task tree to the target task tree to produce a tuned target task tree;
incorporating at least some of the transferred hyperparameter data from the tuned target task tree into a machine learning model.

10. The system of claim 9, wherein the instructions, when executed by the at least one processor, further cause the system to be capable of performing operations comprising constructing the target task tree by assigning the plurality of ground-truth machine learning model hyperparameter-objective function data pairs to particular nodes of the target task tree according to a decision rule that relates to a performance criterion for the machine learning model.

11. The system of claim 9, wherein the instructions, when executed by the at least one processor, further cause the system to be capable of performing operations comprising computing the similarity metric by fitting ground-truth machine learning model hyperparameter-objective function data pairs of leaf nodes of the target task tree to leaf nodes of the reference task tree, and performing pairwise comparisons of the fitted ground-truth machine learning model hyperparameter-objective function data pairs to historical tuned machine learning model hyperparameter-objective function data pairs of the leaf nodes of the reference task tree.

12. The system of claim 11, wherein the instructions, when executed by the at least one processor, further cause the system to be capable of performing operations comprising computing the similarity metric by computing a Kendall Tau-b rank correlation coefficient based on the pairwise comparisons of the fitted ground-truth machine learning model hyperparameter-objective function data pairs to the historical tuned machine learning model hyperparameter-objective function data pairs of the leaf nodes of the reference task tree.

13. The system of claim 9, wherein the instructions, when executed by the at least one processor, further cause the system to be capable of performing operations comprising computing the similarity metric by creating target task tree leaf node subspace-reference task tree leaf node subspace pairs, and calculating an intersection over union score using the target task tree leaf node subspace-reference task tree leaf node subspace pairs.

14. The system of claim 9, wherein the instructions, when executed by the at least one processor, further cause the system to be capable of performing operations comprising using a tournament selection method to randomly select k reference task trees of the at least two reference task trees, where k is greater than one and less than T, where T is a total number of reference task trees, and selecting the reference task tree as having a highest value of the similarity metric from among the k reference task trees.

15. The system of claim 9, wherein the instructions, when executed by the at least one processor, cause the system to be capable of performing operations comprising iteratively performing at least one of a ointwise transfer of a particular hyperparameter value of a particular leaf node of the reference task tree to the target task tree and a spacewise transfer of a search space of the particular leaf node to the target task tree.

16. The system of claim 9, wherein the instructions, when executed by the at least one processor, cause the system to be capable of performing operations comprising stopping the transferring of hyperparameter data from the selected reference task tree to the target task tree when a rejecting rule that relates to a performance criterion of the machine learning model is satisfied.

17. A system, comprising:
at least one processor;
computer memory operably coupled to the at least one processor;
means for configuring the computer memory according to a tuned target task tree;
the tuned target task tree created by transferring hyperparameter data from a selected reference task tree to a target task tree;
the selected reference task tree selected from a plurality of reference task trees based on similarity metrics;
the similarity metrics computed, for each reference task tree of the plurality of reference task trees, between the reference task tree and the target task tree.

18. The system of claim 17, wherein the plurality of reference task trees each have been constructed using different reference task data sets each comprising a plurality of historical hyperparameter-objective function data pairs for a different reference hyperparameter tuning task.

19. The system of claim 17, wherein the target task tree is a tree-based representation of a machine learning model hyperparameter tuning task.

20. The system of claim 19, wherein the target task tree has been created using a target task data set that comprises a plurality of ground-truth hyperparameter-objective function data pairs for the machine learning model hyperparameter tuning task.
